(19) United States
(12) Patent Application Publication
(10) Pub. No.: US 2026/0279975 A1
(43) Pub. Date: Sep. 17, 2026

(54) BATTERY CELL

(71) Applicant: TOYOTA JIDOSHA KABUSHIKI KAISHA, Toyota-shi (JP)

(72) Inventors: Satoshi Nakashima, Toyota-shi (JP); Atsushi Sugihara, Toyota-shi (JP); Masato Ono, Nagoya-shi (JP); Masayoshi Haga, Nagoya-shi (JP); Jun Izumi, Toyota-shi (JP); Masahiro Ishizuka, Toyota-shi (JP); Kenta Miyahara, Toyohashi-shi (JP)

(73) Assignee: TOYOTA JIDOSHA KABUSHIKI KAISHA, Toyota-shi (JP)

(21) Appl. No.: 19/441,179

(22) Filed: Jan. 6, 2026

(30) Foreign Application Priority Data
Mar. 13, 2025 (JP) 2025-040248

(51) Int. Cl. H01M 50/105

(52) U.S. Cl. CPC H01M 50/105

(57) ABSTRACT

A battery cell includes: a power storage body; and an outer casing. The outer casing includes a first film portion and a second film portion. A weld portion in which the first film portion and the second film portion are welded to each other such that an inner surface of the first film portion and an inner surface of the second film portion are in contact with each other is provided around the power storage body. The second film portion in the weld portion includes a first portion that is welded to the inner surface of the first film portion, a bent portion that is bent along a distal end of the first film portion, and a second portion that is connected to the first portion through the bent portion and is welded to an outer surface of the first film portion.

### CROSS-REFERENCE TO RELATED APPLICATION

This application claims priority to Japanese Patent Application No. 2025-040248 filed on March 13, 2025. The disclosure of the above-identified application, including the specification, drawings, and claims, is incorporated by reference herein in its entirety.

### BACKGROUND

### Technical Field

A technology disclosed in the present specification relates to a battery cell.

### Description of Related Art

A battery cell disclosed in Japanese Unexamined Patent Application Publication No. 2020-68197 (JP 2020-68197 A) includes a power storage body and an outer casing that accommodates the power storage body. The outer casing includes a first film portion that covers a first surface of the power storage body, and a second film portion that covers a second surface of the power storage body. A weld portion in which the first film portion and the second film portion are welded to each other is provided around the power storage body. In the weld portion, the outer casing is sealed.

### SUMMARY

In a case where sealability of the weld portion is deteriorated, a gas and a liquid are likely to move between the inside and the outside of the outer casing via the weld portion, and quality of the battery cell is deteriorated. In the present specification, a technology for achieving high sealability in a weld portion is proposed.

A battery cell disclosed in the present specification includes a power storage body, and an outer casing accommodating the power storage body. The outer casing includes a first film portion covering a first surface of the power storage body, and a second film portion covering a second surface of the power storage body, the second surface being opposite to the first surface. A weld portion in which the first film portion and the second film portion are welded to each other such that an inner surface of the first film portion and an inner surface of the second film portion are in contact with each other is provided around the power storage body. The first film portion in the weld portion includes a first portion welded to the inner surface of the second film portion, a bent portion bent along a distal end of the second film portion, and a second portion connected to the first portion via the bent portion and welded to an outer surface of the second film portion.

In the battery cell, the second film portion extends from a position in contact with the inner surface of the first film portion to a position in contact with an outer surface of the first film portion via the bent portion. In addition, the second film portion is welded to the inner surface and the outer surface of the first film portion. Therefore, high sealability can be achieved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery cell 10;

FIG. 2 is a plan view of the battery cell 10 as viewed along a thickness direction;

FIG. 3 is a cross-sectional view of the battery cell before sealing of an outer casing;

FIG. 4 is a cross-sectional view of a reinforced weld portion before sealing;

FIG. 5 is a cross-sectional view of the reinforced weld portion; and

FIG. 6 is a cross-sectional view of a reinforced weld portion of a comparative example.

### DETAILED DESCRIPTION OF EMBODIMENTS

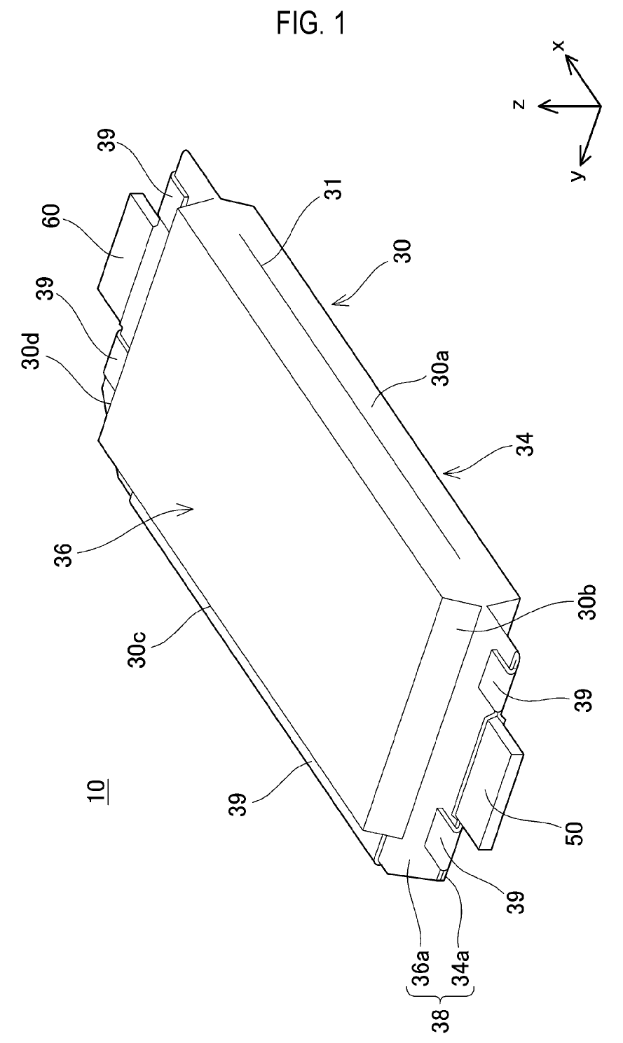

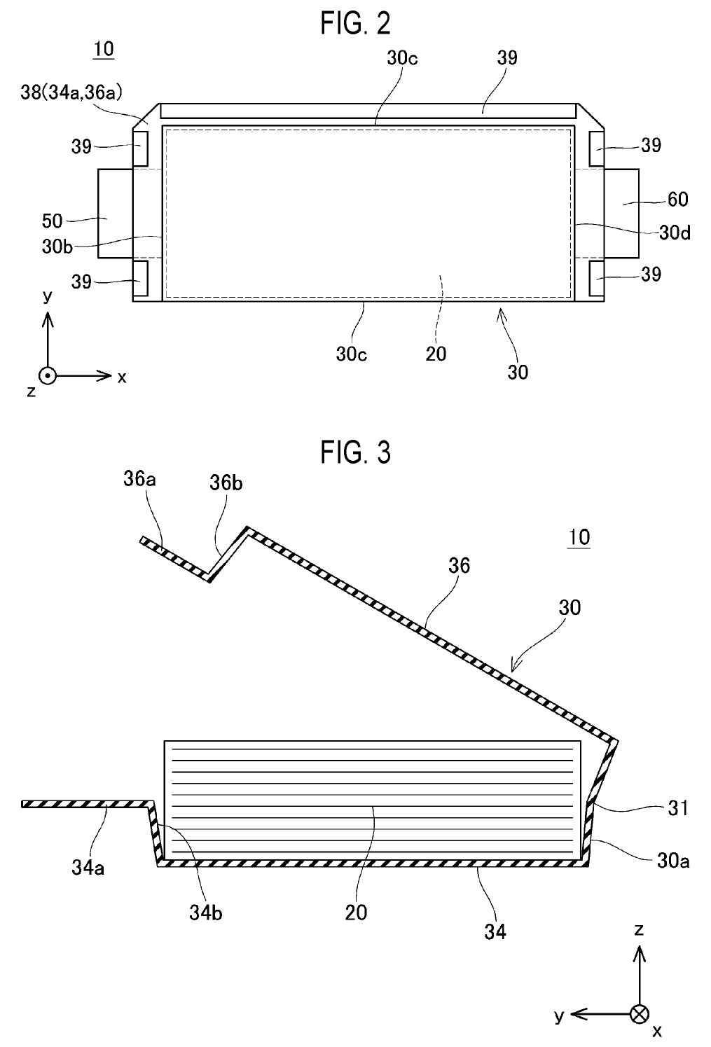

As shown in FIG. 1, the battery cell 10 of the embodiment has a rectangular flat plate shape. Hereinafter, the thickness direction of the battery cell 10 is referred to as a z direction, the longitudinal direction of the battery cell 10 is referred to as an x direction, and a direction orthogonal to the z direction and the x direction is referred to as a y direction. While the battery cell 10 is used, a plurality of the battery cells 10 is laminated in the z direction to constitute a battery module. As shown in FIG. 2, the battery cell 10 includes an outer casing 30 and a power storage body 20 accommodated in the outer casing 30. In addition, electrode plates 50, 60 are provided at both end portions of the battery cell 10 in the x direction. The electrode plate 50 is a positive electrode of the battery cell 10, and the electrode plate 60 is a negative electrode of the battery cell 10.

The power storage body 20 is a chargeable and dischargeable battery element and outputs a direct current voltage. The power storage body 20 is a laminate in which a plurality of positive electrode current collection foils and a plurality of negative electrode current collection foils are laminated in the z direction through a separator in an alternating manner. Although not shown, a foil-collecting portion in which the positive electrode current collection foil is collected is provided at a first end portion of the power storage body 20 in the x direction. The electrode plate 50 is connected to the foil-collecting portion of the positive electrode. Although not shown, a foil-collecting portion in which the negative electrode current collection foil is collected is provided at a second end portion of the power storage body 20 in the x direction. The electrode plate 60 is connected to the foil-collecting portion of the negative electrode. The power storage body 20 is immersed in an electrolytic solution filled in the outer casing 30.

As shown in FIGS. 1 and 2, the outer casing 30 includes side surfaces 30a to 30d. The side surfaces 30a, 30c are side surfaces along the x direction. The side surfaces 30b, 30d are side surfaces along the y direction. FIG. 3 is a cross-sectional view of the battery cell 10 before the outer casing 30 is sealed. As shown in FIG. 3, the outer casing 30 is configured by a thin film. The film constituting the outer casing 30 is a laminate film in which a resin coating film is provided on both surfaces of an aluminum foil. The film constituting the outer casing 30 is molded into a container shape having a bottom portion 34 and a lid portion 36 by an embossing process. An upper surface of the bottom portion 34 and a lower surface of the lid portion 36 constitute an inner surface of the outer casing 30. A lower surface of the bottom portion 34 and an upper surface of the lid portion 36 constitute an outer surface of the outer casing 30. A fold line 31 is provided on the side surface 30a of the outer casing 30. The lid portion 36 can swing with respect to the bottom portion 34 about the fold line 31. The bottom portion 34 includes a frame portion 34a and a cup portion 34b. The cup portion 34b has a cup shape having a recessed portion on an upper surface. The frame portion 34a is a planar portion provided around the cup portion 34b. The frame portion 34a is provided around the cup portion 34b, excluding the side surface 30a. The power storage body 20 is disposed in the cup portion 34b. The lower surface of the power storage body 20 is covered with the cup portion 34b. The lid portion 36 includes a frame portion 36a and a cap portion 36b. The cap portion 36b has a cap shape having a recessed portion on a lower surface. The frame portion 36a is a planar portion provided around the cap portion 36b. The frame portion 36a is provided around the cap portion 36b, excluding the side surface 30a. In a case where the lid portion 36 is closed, the cap portion 36b covers an upper surface of the power storage body 20. In addition, in a case where the lid portion 36 is closed, the frame portion 36a is laminated on the frame portion 34a. In a portion where the frame portion 36a and the frame portion 34a overlap each other, the frame portion 36a and the frame portion 34a are connected to each other by welding. Hereinafter, a portion where the frame portion 36a and the frame portion 34a overlap each other is referred to as a weld portion 38.

As shown in FIGS. 1 and 2, the electrode plates 50, 60 extend from the power storage body 20 to the outside of the outer casing 30. The electrode plates 50, 60 extend from the inside to the outside of the outer casing 30 through an interface between the frame portion 36a and the frame portion 34a. In the weld portion 38, the frame portion 34a is connected to the frame portion 36a by thermal welding. In a region where the electrode plates 50, 60 are not present in the weld portion 38, the frame portion 34a is welded to the frame portion 36a. In a region where the electrode plate 50 is present in the weld portion 38, the frame portion 34a is welded to a lower surface of the electrode plate 50, and the frame portion 36a is welded to an upper surface of the electrode plate 50. In a region where the electrode plate 60 is present in the weld portion 38, the frame portion 34a is welded to a lower surface of the electrode plate 60, and the frame portion 36a is welded to an upper surface of the electrode plate 60. In the weld portion 38, the outer casing 30 is sealed.

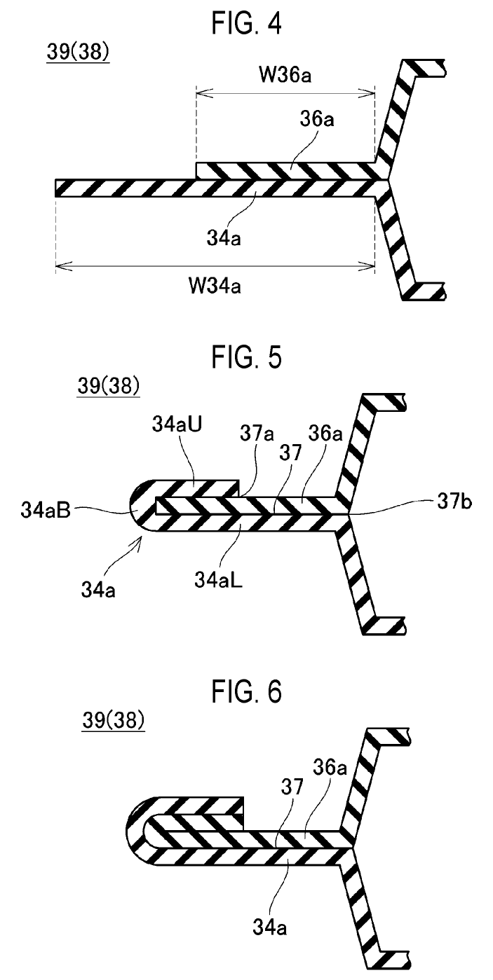

As shown in FIGS. 1 and 2, a plurality of reinforced weld portions 39 in which the frame portion 34a is bent is provided in the weld portion 38. FIG. 4 shows the reinforced weld portion 39 before welding. FIG. 4 shows a cross-section of the reinforced weld portion 39 in a width direction of the weld portion 38. As shown in FIG. 4, in the reinforced weld portion 39, a width W34a of the frame portion 34a is larger than a width W36a of the frame portion 36a. Therefore, the frame portion 34a protrudes outward of an outer peripheral edge of the frame portion 36a. Before the outer casing 30 is sealed, as shown in FIG. 5, a protruding portion of the frame portion 34a is bent along the frame portion 36a. Therefore, the frame portion 34a includes a first portion 34aL in contact with a lower surface of the frame portion 36a, a bent portion 34aB bent along an outer peripheral edge of the frame portion 36a, and a second portion 34aU in contact with an upper surface of the frame portion 36a. The second portion 34aU is connected to the first portion 34aL through the bent portion 34aB. In a case where the outer casing 30 is sealed, the first portion 34aL is welded to the lower surface of the frame portion 36a, and the second portion 34aU is welded to the upper surface of the frame portion 36a.

With the structure of the reinforced weld portion 39 shown in FIG. 5, the frame portion 34a is welded across the lower surface and the upper surface of the frame portion 36a. Therefore, a length of the interface 37 between the frame portion 34a and the frame portion 36a (that is, a length from an outer end portion 37a to an inner end portion 37b of the interface 37) is long, and it is difficult for a gas and a liquid to pass through the interface 37. Therefore, by providing the reinforced weld portion 39 in the weld portion 38, the sealability of the outer casing 30 is improved. For example, it is possible to suppress the ingress of a gas and a liquid from the outside to the inside of the outer casing 30. In addition, it is possible to suppress the leakage of a gas and a liquid from the inside to the outside of the outer casing 30. As described above, by providing the reinforced weld portion 39, it is possible to achieve a high-quality battery cell 10.

In addition, since the frame portion 34a is bent in the reinforced weld portion 39, the length of the interface 37 can be increased without increasing the width of the weld portion 38. Therefore, with this structure, it is possible to achieve high sealability without increasing the size of the battery cell 10. As shown in FIG. 6, even in a case where the frame portion 34a and the frame portion 36a have the same width and the frame portion 34a and the frame portion 36a are bent together, the distance of the interface 37 can be increased without increasing the width of the weld portion 38. However, in this case, the thickness of the weld portion 38 is increased. In addition, in a portion where the frame portion 34a and the frame portion 36a are bent together, the adhesiveness between the frame portion 34a and the frame portion 36a is deteriorated. In addition, since the frame portion 36a is bent with a high curvature at the bent portion, the frame portion 36a is likely to deteriorate. In the configuration of FIG. 5, the sealability can be improved without causing such a problem.

The lower surface of the power storage body according to the embodiment is an example of the first surface. The upper surface of the power storage body according to the embodiment is an example of the second surface. The bottom portion 34 according to the embodiment is an example of the first film portion. The lid portion 36 according to the embodiment is an example of the second film portion.

Although the embodiments have been described in detail above, these are merely an example and do not limit the scope of claims. The techniques described in the claims include various modifications and changes of the specific examples exemplified above. The technical elements described in the present specification or the drawings exhibit technical usefulness alone or in various combinations, and are not limited to the combinations described in the claims at the time of filing. Further, the techniques exemplified in the present specification or the drawings achieve a plurality of objectives at the same time, and achieving one of the objectives itself has technical usefulness.

What is claimed is:

1. A battery cell comprising:
a power storage body; and
an outer casing accommodating the power storage body, wherein:
the outer casing includes
a first film portion covering a first surface of the power storage body, and
a second film portion covering a second surface of the power storage body, the second surface being opposite to the first surface;
a weld portion in which the first film portion and the second film portion are welded to each other such that an inner surface of the first film portion and an inner surface of the second film portion are in contact with each other is provided around the power storage body; and
the first film portion in the weld portion includes
a first portion welded to the inner surface of the second film portion,
a bent portion bent along a distal end of the second film portion, and
a second portion connected to the first portion via the bent portion and welded to an outer surface of the second film portion.
